(19) United States
(12) Patent Application Publication
(10) Pub. No.: US 2007/0067403 A1
(43) Pub. Date: Mar. 22, 2007

(54) Data Delivery System

(76) Inventor: Grant Holmes, Massillon, OH (US)

Correspondence Address: ADVANTIA LAW GROUP, 9035 SOUTH 1300 EAST, SUITE 200, SANDY, UT, 84094, US

(21) Appl. No.: 11/458,969

(22) Filed: Jul. 20, 2006

Related U.S. Application Data
(60) Provisional application No. 60/701,382, filed on Jul. 20, 2005.

(51) Int. Cl. G06F 15/16

(52) U.S. Cl. 709/206

(57) ABSTRACT

A controlled delivery system, method, and article of manufacture that includes a network module, configured to access a network; a storage module, configured to store data; a data publishing module in communication with the network module and storage module, configured to enable a data provider to upload and select a first and second condition; a permission module, configured to provide access to the system upon satisfaction of a first condition and delivery of a data set upon satisfaction of a second condition. The second condition may be a selected data receiver class, or a plurality of conditions configured to control delivery of data sets. The system also comprises a receiving module including a condition satisfaction module, configured to enable a data receiver to satisfy a second condition; a facilitating module notifies a data receiver of a first data set.

### CROSS-REFERENCE TO RELATED APPLICATIONS

This invention claims priority, under 35 U.S.C. § 120, to the U.S. Provisional Patent Application No. US60/702,382 filed on Jul. 20, 2005, which is incorporated by reference herein.

### FIELD OF THE INVENTION

The present invention relates to a receipt and delivery system for data; specifically to a system, method, and article of manufacture for controlling messages sent to an administrator, and receiving messages from the administrator at the demand of the message receiver.

### DESCRIPTION OF THE RELATED ART

In the related art, it has been known to use data receivers that demand documents from a centralized source, or a centralized source sending data to intended receivers. A typical problem for data receivers of the internet is the sending of unwanted email messages, also known as spam. This problem occurs because email is typically a push-type message system. A push-type messaging system is one in which the sender determines who receives what messages. In fact, senders can guess and send items to “unknown” email addresses. Some improvements have been made in the field. Examples include but are not limited to the references described below, which references are incorporated by reference herein:

U.S. Patent Publication No.: US 2003/0037102, by Eckert et al., discloses a message broker for transmitting messages from a first data provider system to a second data provider system, the message broker comprising at least one message channel, a first channel adapter and a second channel adapter, the first channel adapter being operable to; receive a message from the first data provider system encoded in an Internet protocol and comprising content information and destination information, read the destination information from the message, and send a push request to place the message in a message channel corresponding to the destination information, the second channel adapter being operable to; receive a message request from the second data provider system encoded in an Internet protocol and comprising source information, read the message request and identify a message channel corresponding to the source information, send a pull request to the identified channel, and generate a response accordingly.

U.S. Patent Application Publication No.: 2004/0034686, by Guthrie, discloses an information system including a data provider component resident on a computer of the data receiver, a server, and a database storage unit. The server is coupled to the computer and an internet work such as the Internet. The server collects electronic information corresponding to a data receiver's predetermined customized profile for delivery to the data provider component from the internet sites and the server. The database storage unit is coupled to the server. Electronic information collected by the server is used to populate at least one archive stored in the database storage unit. The archive is associated with the data receiver's profile. The server sends checksums identifying the collected electronic information to the data provider component. The data provider component verifies that the electronic information has not previously been sent to the data provider component. The data provider component generates and transmits a message to the server indicating the electronic information that has been previously sent to the data provider component. The server deletes electronic information that has been previously sent to the data provider component from the archive. The server compresses electronic information remaining in the archive into a streaming format and sends the electronic information to the data provider component. The electronic information is decompressed by the data provider component and provided to the data receiver via the computer. The invention also includes related methods.

U.S. Pat. No.: 6,584,466, issued to Serbinis et al., discloses an Internet-based document management system and methods are provided wherein an electronic document may be stored on an Internet-accessible server and accessed using a previously known web browser, downloaded for review or manipulation, and then returned to the server for access by further data receivers. The server is programmed to provide a plurality of services supported by a common database and document store, including storage and retrieval services, an electronic document delivery service, a document distribution service, a collaborative file sharing service and a workflow service. The system preferably also is programmed with a security function, a filtering function, accounting functions that enable detailed accounting of transactions occurring on the system, and a customization function that permits multiple service providers to utilize the common document management services of a server, while presenting end-data receivers with distinct dedicated websites.

U.S. Pat. No.: 6,105,042, issued to Aganovic et al., discloses an information management system permits remote, on-demand storage and retrieval of documents including multimedia content, over low-speed communication links, while requiring only “thin” computing capability and a “thin wire” communication link. Heavy computing and data transfer-intensive processes are concentrated at the back end of the system, enabling the use of low bandwidth communication links. The system additionally includes security and data protection measures for uploading and downloading operations.

U.S. Pat. No.: 6,665,709, issued to Barron, discloses a platform allowing for the secure file transfer from one location to another (internet or intranet) with encryption, secure data storage, and a simple web-based data receiver interface. A data receiver accesses the system by a data-base authentication system requiring data receiver name and password. The program residing on the server then generates an encryption sequence. A temporary file is created on the data receivers' machine upon which the data receiver uploads the information to be sent. The information is automatically encrypted by the program and transferred to the server and the data receiver's temporary file deleted. The information is stored in the program on the server until the recipient downloads it. The recipient also accesses the server by a data receiver name and password. The program generates a decryption program. The recipient's machine receives the applet program to decrypt the file and a copy of the encrypted file. After decryption is complete, the program saves the files to a specified recipient folder, and can be automatically deleted or archived.

U.S. Patent Application Publication No.: 2005/0108200, by Meik et al., discloses an integrated, automatic and open information retrieval system comprising an hybrid method based on linguistic and mathematical approaches for an automatic text categorization. It combines an automatic content recognition technique with a self-learning hierarchical scheme of indexed categories. In response to a word submitted by a requester, said system retrieves documents containing that word, analyzes the documents to determine their word-pair patterns, matches the document patterns to database patterns that are related to topics, and thereby assigns topics to each document. If the retrieved documents are assigned to more than one topic, a list of the document topics is presented to the requester, and the requester designates the relevant topics. The requester is then granted access only to documents assigned to relevant topics. A knowledge database linking search terms to documents and documents to topics is established and maintained to speed future searches.

U.S. Pat. No.: 6,424,718, issued to Holloway, discloses a communications system in which messages may be processed using public key cryptography with a private key (SKu) unique to one or more data receivers. The system comprises a server means adapted for data communication with a data provider via a network, the server means comprising first data storage means in which is stored in a private key for the or each data receiver, the private key being encrypted with a key encrypting key. The server means further comprises second data storage means in which is stored applet code executable on the data provider. The server provides the applet code to the data provider via the network in response to connection of the data provider to the server via the network. The applet code comprises processing means operable, when executed in the data provider, to receive a message to be processed from the data receiver, to retrieve the encrypted private key for the data receiver from the server means via the network, to receive the key encrypting key from the data receiver, to decrypt the private key using the key encrypting key, and to perform the public key processing for the message using the decrypted private key. The applet code and the associated keys are removed from the data provider on termination of the applet code.

U.S. Pat. No.: 6,356,941, issued to Cohen, discloses a system for data storage, exchange and/or sharing through a central storage facility, containing at least one “network vault” to which access is controlled through a single data access channel. The network vault is similar to a physical safe, in that substantially any type of information can be stored in the network vault, and in that the data receiver need only place the information inside the network vault for the information to be secured.

U.S. Patent Application Publication No.: 2005/0066194, by Campbell et al., discloses a web server system provides for the exchanging files with a remote transfer server over an open network such as the Internet. The transfer server operates a plurality of transfer methods. Exemplary transfer methods comprise: i) a log-on method operated comprising steps for returning a session ID to an authenticated transfer data provider; ii) an active event keys method comprising steps for returning each of a plurality of event keys associated with the transfer data provider; iii) a read event method comprising steps for returning event parameters associated with an event identified by its event key, iv) a create binary object event comprising steps for extracting data from an application database, storing a binary object of the extracted data, and recording the binary object in an ownership table, v) a check availability method for determining whether a binary object matching a class exists; and vi) a download method comprising steps for sending a message to the transfer data provider which includes a binary object identified in a request from the transfer data provider.

U.S. Patent Application Publication No.: 2005/0086298, by Campbell et al., discloses a system provides for the exchanging files with a remote transfer server over an open network such as the Internet. The system comprises a database with file transfer tables, a hypertext transport protocol (HTTP) server, and a web services server. The HTTP server is coupled to the database and provides web pages to an HTTP data provider to obtain file transfer event parameters and identification of a remote file transfer data provider to which the file transfer event parameters are associated. The file transfer event parameters are stored in the file transfer tables in association with the identification of the remote file transfer data provider. The web services server comprising a plurality of transfer methods. The transfer methods comprises: i) a method for associating a remote transfer data provider with a session ID; ii) a method for providing to the remote transfer data provider the file transfer event parameters that are associated with the remote transfer data provider in response to receiving a method call from the remote transfer data provider; and iii) a method call for executing a file exchange with the remote transfer data provider in response to receiving a method call from the remote transfer data provider that includes the file transfer parameters.

U.S. Pat. No.: 6,681,017, issued to Matias et al., discloses a number of protocols for providing security for a series of low-cost transactions carried out between a data provider and a server within an on-going data provider-server relationship. A key establishment protocol is used to generate a shared key which will be used by the data provider and server for the series of transactions. The data provider generates the shared key as a function of a data provider identifier, a server identifier and secret data provider information, encrypts the shared key using a public key of the server, and sends the encrypted shared key to the server. The server responds by incorporating server information into a response which is encrypted using the shared key and sent to the data provider. The data provider decrypts the response, verifies that the server has accepted the shared key, and then sends additional data provider information, such as a credit card number, to the server, using the shared key for encryption. The data provider may then use the shared key in a series of subsequent transactions with the server. The subsequent transactions may be in accordance with a data delivery protocol in which the data provider requests information and the server supplies the information encrypted using the shared key. The server may require that the data provider demonstrate possession of the shared key before responding to a data delivery request. The generation and use of the shared key may be made substantially transparent to the data provider through the use of a data provider-side web proxy.

U.S. Patent Application Publication No.: 2005/0021640, by Dalen, discloses a method for transferring generic data acquired at a remote location to a central database based on e-mail communication, comprising encapsulating the acquired data in an electronic mail message, sending the electronic mail through a network (public or private) to a central database server, extracting the data from the electronic mail message by the central database server, and storing the extracted data in the central database. The acquired data is communicated directly to the database server by providing an architecture for Internet communication software for embedded platforms, the architecture being based on a network of software multiplexers and de-multiplexers, controlled by an integrated protocol engine.

U.S. Patent Application Publication No.: 2003/0055826, by Graham, discloses systems and methods for facilitating communications with and control of disparate databases via an electronic data network, such as the Internet and WWW. The systems and methods include a database interface system for interfacing data provider applications to a database. The database interface system includes a data source driver and an interface facility. The data source driver is related to the database and is configured to allow operative access to the database via an electronic data network. The interface facility is coupled to the electronic data network and is configured to accept a message from a data provider coupled to an electronic data network and configured to send and receive messages containing a character sting (e.g., a request for data, etc.) to access the database via the database source driver based on the character string within the message, to perform a database operation in the database based on the character string, and to return a message to the data provider corresponding to the executed database operation.

U.S. Pat. No.: 6,115,712, issued to Islam et al., discloses an open architecture for arbitrarily combining data analysis algorithms and databases on the Internet where the data analysis algorithm and database may be from different vendors or suppliers. At the request of a customer, the two are combined on the fly while maintaining proper security and while enforcing some agreed upon payment from the customer to both the algorithm and database suppliers. In one embodiment, a message including an identifier of a data receiver selected independent content provider and an identifier of a particular service associated with a service provider is sent to the service provider on a communication network. The data receiver selected independent content provider is separate from the service provider. In response to the message, a computer executable code, which when executed by the content provider will cause the particular service to be performed against content controlled by the content provider, is sent from the service provider to the content provider. The computer executable code is executed by the content provider and at least partial results of the executing are returned to the data receiver by way of the communication network.

U.S. Patent Application Publication No.: 2002/0065890, by Barron, discloses an Internet based, accessed, manipulated and administered automated outbound message delivery method and system. The present method and system allows the data receiver to transmit a message to a database comprised of phone numbers, pager numbers, fax numbers, e-mail addresses and mailing addresses. A call initiator sets the message delivery parameters and the message is then transmitted to the database through a plurality of outgoing phone lines.

U.S. Pat. No.: 6,857,074, issued to Bobo, II, discloses a Message Storage and Deliver System (MSDS) that is connected to the public switched telephone network (PSTN) and receives incoming calls with these calls being facsimile, voice, or data transmissions. The MSDS detects the type of call and stores the message signal in a database. The MSDS is also connected to the Internet and has a hyper-text transfer protocol deamon (HTTPD) for receiving requests from data receivers. The HTTPD forwards requests for certain files or messages to a network server which transmits at least part of the message to the HTTPD and then to the data receiver. In addition to requests for certain documents, the HTTPD may also receive a request in the form of a search query. The search query is forwarded from the HTTPD to an application program for conducting the search of the database. The results of the search are forwarded through the HTTPD to the data receiver. The data receiver may then select one or more files or messages from the search results and may save the search for later reference.

The inventions heretofore known suffer from a number of disadvantages which include the delivery of data or messages to a recipient in a random or undesired order; the inability of data providers to control and manage the flow and direction of how data is received by data receivers; the unwanted receipt of advertising and/or spam emails; data being delivered via compression/decompression, which can cause viruses or other unwanted programs to enter the recipients' system; and finally, even where a email address is unknown but contains a recognized domain name (i.e. @hotmail.com, etc.), a simple algorithm can be run to acquire email addresses.

What is needed is a data delivery system that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available data delivery systems. Accordingly, the present invention has been developed to provide a controlled delivery system, method, device and/or article of manufacture that may include one or more of the functions, features, etc. described below.

In one embodiment of the invention, there is system for controlling delivery of data. The system includes one or more of the following: a network module configured to send and receive data; a storage module configured to store data; a data publisher module in communication with the network module and the storage module, configure to enable a data provider to upload and select a first and second condition; and a permission module configured to provide access to the data upon satisfaction of one condition and delivery of a data set upon satisfaction of a second condition. The first condition may be satisfied by the presentation of a key. The key may include a data receiver class configured to categorize. The second condition may include a selected data receiver class. The second condition may also include a preliminary data set and/or receipt of confirmation of a preliminary data set. The second condition may also be selected from the group of conditions including: a passage of a first time period, a passage of time, a delivery of preliminary data set, a passage of a date, a date, an indication of approval from a data provider, an indication of approval from a third party, and/or a credit expenditure. The system may also include a first data set that is randomly selected from a plurality of data sets. Access to metadata may be provided upon occurrence of a first condition.

The system may also include a receiving module and/or a facilitating module. The receiving module may be in communication with the network module configured to receive data. The receiving module may also include a condition satisfaction module that is configured to enable a data receiver to satisfy a second condition. The facilitating module may be configured to notify a receiver of the receipt of a first data set.

In another embodiment of the invention, there is a method that may be used for controlling the delivery of data. The method may include: providing access to a network; receiving data; storing data; receiving a selection of a first condition; receiving a selection of a second condition; providing access to data upon satisfaction of the first condition; delivering the data set upon satisfaction of the second condition. The method may also include a second condition comprising: a preliminary data set, or a second condition which may be selected from a group of conditions including: a passage of a first time period; a passage of time; a deliver of a preliminary data set; a passage of a date; a date; an indication of approval from a data provider; an indication of approval from a third party; and/or a credit expenditure.

In a still further embodiment, there may be an article of manufacture. The article of manufacture may include a computer usable medium having computer readable program code embodied therein, the computer readable program code may provide instruction for carrying out the steps of: providing access to a network; receiving data; storing data; receiving a selection of a first condition; receiving a selection of a second condition; providing access to data upon satisfaction of the first condition; delivering the data set upon satisfaction of the second condition. The second condition may be selected from a group including: a passage of a first time period; a passage of time; a delivery of a preliminary data set; a passage of a date; a date; an indication of approval from a data provider; an indication of approval from a third party; and a credit expenditure.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a block diagram showing a system for controlling delivery of data;

FIG. 2 is a sequence diagram showing message delivery according to one embodiment of the invention in operation;

FIG. 3 is a sequence diagram showing message delivery according to one embodiment of the invention;

FIG. 4 is a sequence diagram showing message delivery according to one embodiment of the invention in operation

FIG. 5 is a block diagram showing an administration module according to one embodiment of the invention.

FIG. 6 is a block diagram showing a data receiving module according to one embodiment of the invention.

### DETAILED DESCRIPTION OF THE INVENTION

For the purposes of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to “one embodiment,” “an embodiment,” or similar language means that a particular feature, structure, or characteristic described in connection with the embodiment is included in at least one embodiment of the present invention. Thus, appearances of the phrases “one embodiment,” “an embodiment,” and similar language throughout this specification may, but do not necessarily, all refer to the same embodiment, different embodiments, or component parts of the same or different illustrated invention. Additionally, reference to the wording “an embodiment,” or the like, for two or more features, elements, etc. does not mean that the features are related, dissimilar, the same, etc. The use of the term “an embodiment,” or similar wording, is merely a convenient phrase to indicate optional features, which may or may not be part of the invention as claimed.

Each statement of an embodiment is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The independent embodiments are considered to be able to be combined in whole or in part one with another as the claims and/or art may direct, either directly or indirectly, implicitly or explicitly.

Finally, the fact that the wording “an embodiment,” or the like, does not appear at the beginning of every sentence in the specification, such as is the practice of some practitioners, is merely a convenience for the reader's clarity. However, it is the intention of this application to incorporate by reference the phrasing “an embodiment,” and the like, at the beginning of every sentence herein where logically possible and appropriate.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

As used herein, “meta-data” refers to information about a set of data. For example, wherein a particular set of data information may be a message file, like an e-mail; “meta-data” may be the title of the e-mail, the size of the e-mail, the source of the e-mail, etc.

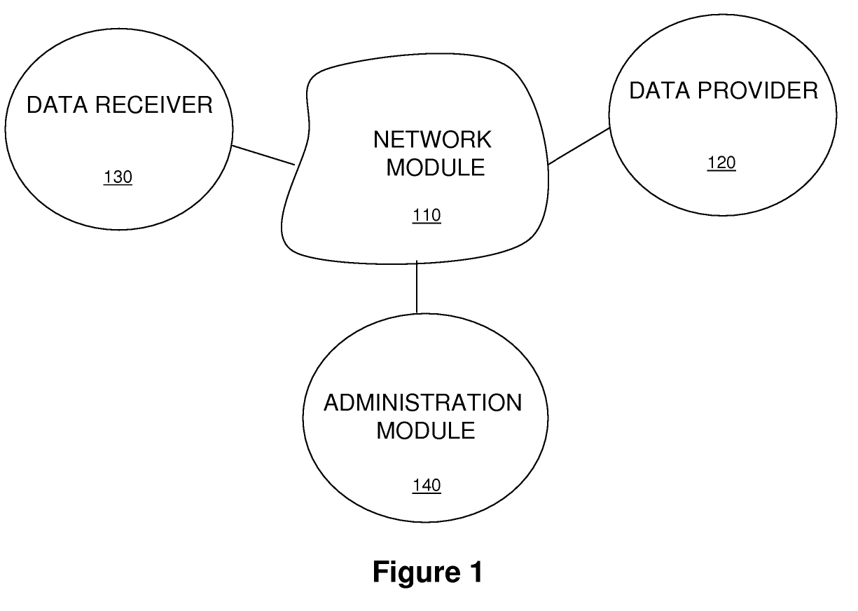

Looking to FIG. 1, there is shown a data provider 120, a data receiver 130, and an administrator 140, all in communication via a global network 110, such as the internet. The global network 110 may include the internet, an intranet, a local network, and/or another LAN or WAN system. The administration module 140 may be in communication via a global network 110 to a plurality of data receivers 130 and/or data providers. The administration module 140 may or may not include a website wherein the data provider 120 a data receiver 130 may access the administration module 140. Some non-limiting examples of a data provider 120 and/or data receivers 130 may include: a professional; a corporation; an employer; a project manager; a client; an educational institution and/or teacher, an entertainment producer; a media publisher; a data consumer; an employee; a member of a social network; student; and so forth.

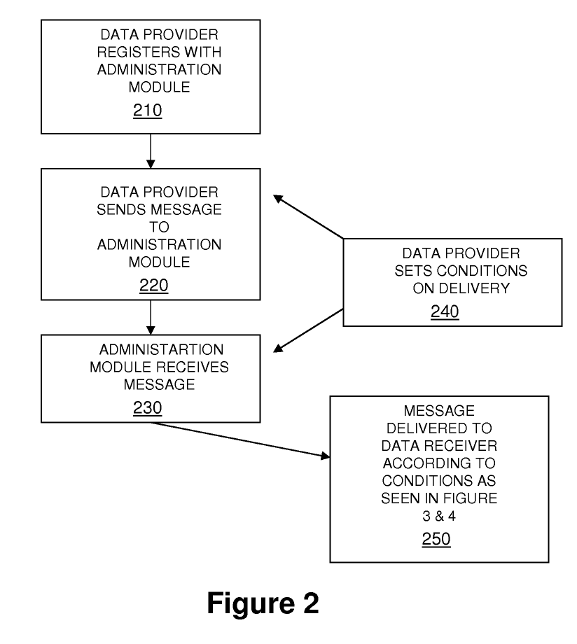

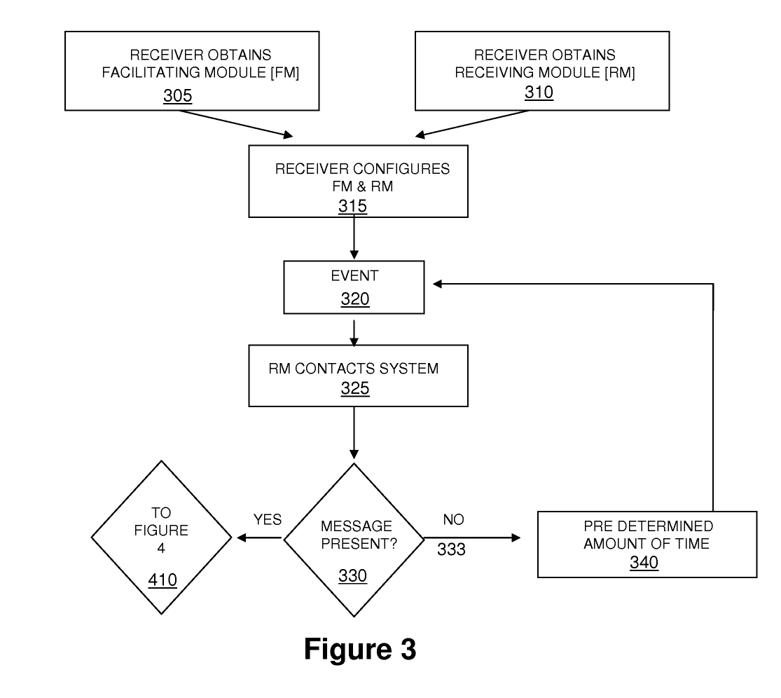

FIG. 2 and 3 illustrate a sequence diagram showing an embodiment of the invention in operation wherein the data comprises a message. Looking at FIG. 2, to enable a data provider 120 to deliver a message through the system 100, a data provider 120 should first register 210 with the administration module 140. This can be accomplished by any means know in the art. In a non-limiting example, once registered, a data provider's 120 allowances will be set. Some non-limiting allowances include: number of messages sent by a data provider 120, the number of data receivers 130 that may receive the message, the content of the messages, the number of time the messages may be sent or received, and so forth.

In another embodiment, the data provider 120 allowances may be set such that a data provider 120 may send messages to an unlimited number of data receivers 130. In yet another embodiment, the allowances are set such that only a limited number of data receivers 130 may receive the messages. As a non-limiting example, a data provider 120 may purchase a limited number of licenses from the administration module 140. In this way a data provider's 120 allowances are set such that only the number of data receivers that is equal to the number of licenses purchased may receive the message. Any data receiver 130 that attempts to receive the message after the number of data receivers 130 that have received the message equals the number of licenses sold, will be denied access to the message.

Also shown in FIG. 2, a data provider 120 may elect to set one or more conditions for delivery of the message 240 or may elect to wait until the message is received 230 by the administration module 140. A data provider 120 may also set the conditions; edit conditions previously set, and/or edit the message previously sent after the message is received 130 by the administration module 140. A data provider 120 may set the conditions via the permission module 450, described in more detail below. Once the conditions set by a data provider 120 have been satisfied, the message is delivered to the data receiver 250.

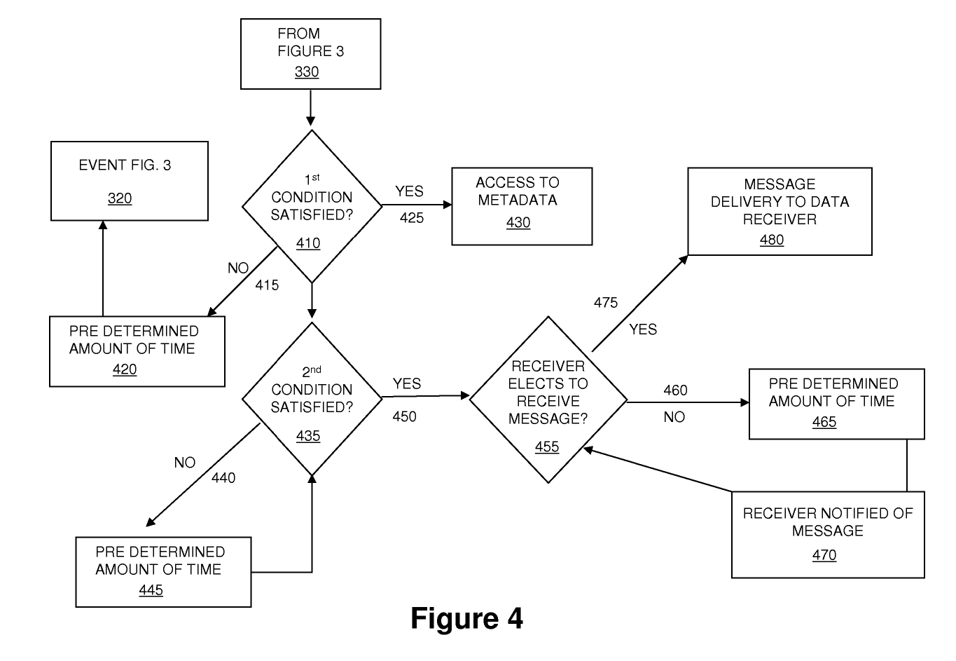

Looking to FIGS. 3 and 4, a data receiver 130 obtains 305, 310 a facilitating module (FM) 640 and a receiving module (RM) 630. The FM 640 and/or RM 630 may be obtained 305, 310 via: a specific data provider 130 and/or a plurality of data providers 130, the administration module 140, a third party, be pre-installed in the data receiver 130, or through any other means understood in the art. The FM 640 and/or the RM 630 may be controlled by: a specific data provider and/or a plurality of data providers 130, the administration module 140, a third party, and/or by any other means understood in the art. A data receiver 130 then configures 315 the FM 640 and RM 630, which may include: installing the FM 640 and/or RM 630, classifying an event 320, setting a pre-determined amount of time 340, 420, 445, 465, setting personalized preferences, and so forth. Non-limiting examples of an event 320 may include: a device being turned on; a device being connected to or connecting to a network, such as the internet; a predetermined time; a module is activated, such as the RM 530 and/or FM 540; the choosing of a defined area above, the depressing of a defined key or button, and any other event understood in the art, as defined by the data receiver 130.

In another embodiment a data receiver 130 may be required to register with the administration module 140 and/or one or more data providers 120. The registration may be done concurrently with the configuration of the RM 630 and/or FM 640. A data receiver 130 may be required to give certain information to the administration module 140. Some non-limiting examples of this information may include: name, location, address, city, zip code, phone number, fax number, a registration code, a credit card number, email address, a password, a data receiver identification, and so forth. The registration process may require that the data receiver 130 give an email address and a pass code. In one embodiment, the pass code is sent to the email address given by the data receiver 130.

As seen in FIG. 3, the RM 630 and/or FM 640 may contact 325 the administration module 140 and/or confirm 330 the presence of a message. This contact may be through any means known to one skilled in the art. Such means may include, for example, direct connection to the administration module 140 through broadband, cable, phone line, satellite, radio frequency, infrared link, the Internet; an intranet; and so forth.

FIG. 3 also shows if there is no message 333 then the RM 630 and/or FM 640 may wait a predetermined amount of time 340 or wait until an event 320 occurs, and may contact 325 the administration module 140, as described in FIG. 3. The FM 640 and/or RM 630 may present options as to the predetermined amount of time 340, 420, 445, 465. A predetermined amount of time 340, 420, 445, 465 may be greater than about 1 second, or greater than about 5 seconds, or greater than about 1 minute; and less than about 1 year, or less than about 1 month, or less than about 1 day. A predetermined amount of time 340, 420, 445, 465 in one embodiment may be set by the data receiver 130. In another embodiment, the predetermined amount of time 340, 420, 445, 465 is set by a data provider 120. In one embodiment, the predetermined amount of time 340, 420, 445, 465 is five minutes.

Looking now to FIG. 4, the administration module 140 then determines if the conditions set by a data provider 240 have been satisfied for access and/or delivery of a related data set. The administration module 140 may verify that the first condition has been satisfied 410. If the response is negative 415, then the RM 630 and/or FM 640 will wait a pre-determined amount of time 420 and/or wait until an event 320 occurs. The RM 630 and/or FM 640 may contact 325 the administration module 140, as described in FIG. 3.

FIG. 4 then illustrates if the first condition established by the data provider has been satisfied 425 a data receiver 130 is allowed access 430 to metadata regarding the message. The administration module 140 next verifies 435 that one or more second conditions set by a data provider 120 have been satisfied. If the response is negative 440 the RM 630 and/or FM 640 will wait a predetermined amount of time 445, then re-verify 435 satisfaction of the second condition. If the one or more second conditions set by a data provider 240 have been satisfied 450 a data receiver 130 may elect 455 to receive the message. If a data receiver elects not to receive 460 the message then the FM 640 and/or AM 630 may wait a pre-determined amount of time 465 then notify 470 a data receiver 130 of the presence of a message. A data receiver 130 may again elect 455 to receive the message or not. If a data receiver 130 elects affirmatively 475 to receive the message, the message is then delivered 480 to a data receiver 130.

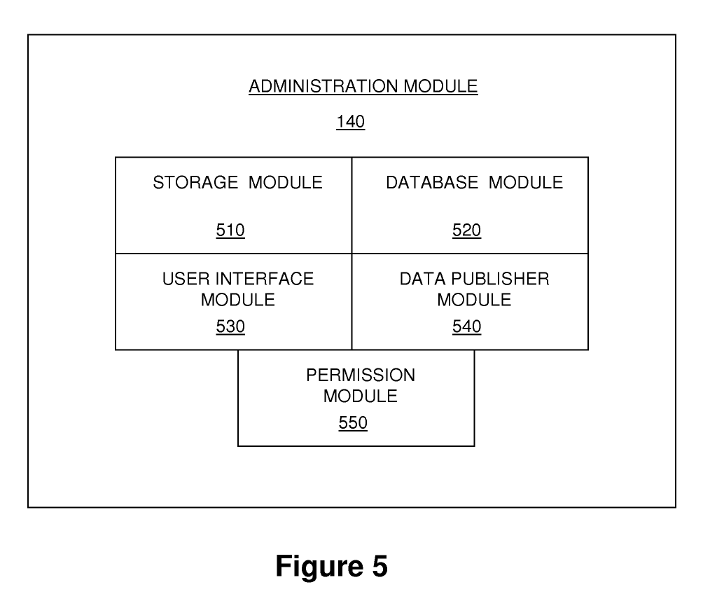

FIG. 5 is a block diagram showing an administration module according to one embodiment of the invention. The administration module 140 includes a plurality of modules for carrying out the functions associated with the administration module 140. There is shown an administration module 140 including: a storage module 510; a database module 520; a user interface module 530; a data publisher module 540; and a permission module 550.

In one embodiment the administration module 140 may manage the services of the administration module 140. Management of the services may include a coordination between which data provider 120 sent which data. Management may include ensuring that a data receiver 130 receives the data when requested. Management may include ensuring that data receivers 130 receive the data according to data providers' 120 conditions. Management of the services may also include creating, adding, and/or registering data providers 120 and/or data receivers 130. Finally, management of services may include managing the security of the administration module 140 and/or the network module 110.

The storage module 510 stores data, such as, but not limited to, message information (e-mails, advertisements, documents), audio information (music files such as mp3 or wav files), video or picture information, and so forth. The storage module 510 may include one or more storage devices, such as but not limited to a hard drive, and may include an OS system such as a Windows or DOS OS by Microsoft Corporation of Redmond, Washington.

The database module 520 stores, organizes, and/or includes meta-data relating to data sets. In one embodiment, MySQL by MySQL AB of Uppsala Sweden is included in the database module 520. In another embodiment the database module 520 may allow a data receiver 130 and/or data provider 120 to monitor statistical information regarding the data. Non-limiting examples of statistics may include: which data has been received; which data providers 120 send which data; to which data receiver 130 is the most data received; from which data provider 120 is the least data received; which data receivers 130 immediately elect to receive the data when the data receiver 130 is notified of the data; which data receiver 130 elects to wait or not receive the data when the data receiver 130 is notified of the data; which data is received more than one time; how many times each data is received; which data receiver 130 repeatedly receives data; which data receiver 130 saves which data; and so forth.

The user interface module 530 includes instructions for controlling interactions with a data receiver and may be written in php with some shell script and C programs. The user interface module 530 may include a list of data providers 120. In one embodiment the user interface module comprises a website and/or web browser that allows the administration module, data providers, and/or data receivers to interact. In another embodiment the user interface module does not include a website and/or web browser. The user interface module 530 may also include a search engine. The search engine may facilitate the searching of a data provider 120 list. A data receiver 130 may select a one or more data providers 120 from the list.

The data publisher module 540 is in communication with the storage module and the network module to enable a data provider 120 to upload data and set a first and second condition. In one embodiment the data publisher module 540 includes an active data publisher, such as available at www.activedat.com.

The permission module 550 may include program code that provides access to the system upon satisfaction of a first condition and delivery of a data set upon satisfaction of a second condition. In one embodiment, the data set is randomly selected from a plurality of data sets. A permission module 550 may include an interface to a database module.

In one embodiment access to metadata is provided upon occurrence of a first condition, wherein the first condition is satisfied by presentation of a key. Non-limiting examples of key may include: a data receiver name, a password, an internet address, and so forth. The key may also include a data receiver class, configured to categorize.

Non-limiting examples of a second condition may include: a preliminary data set; a receipt of confirmation of use of a preliminary data set; a selected data receiver class; and so forth. The second condition may also be selected from a group of conditions including: a passage of a first time period; a passage of time; a deliver of a preliminary data set; a passage of a date; a date; an indication of approval from a data provider; an indication of approval from a third party; and/or a credit expenditure.

In one embodiment, a data provider 130 may set the conditions of the messages. The conditions may be related to any field known in the art. For example, the conditions may be set such that the data may only be received on a specified date, or during a specified time window. A non-limiting example of this condition includes if a data provider 130 sends data with a time-sensitive theme such as, for example, the Fourth of July. A data provider 120 may desire that one or more data receivers 130 only be able to receive this data during a specified time window, for example, from July 1 to July 5. If the data is conditioned to only be received during the specified time window, a data receiver 130 (as described above) will only be able to receive the data if the data is received during the pre-conditioned time window.

data provider 120 may also condition data to be received in a random order. For example, a data provider 120 may send multiple data sets to the administration module 140 and condition them as random. In such a case, a data receiver 130 will receive data sets in a randomized order.

The data provider 120 may send data to the administration module 140, but not wish that the data to be received at all. In such a case, the data provider 120 may condition the data such that it cannot be received. The data provider 120 may re-condition the data to be received in any manner that the data may be conditioned. In one embodiment the condition may be not just based on a mere GUI interaction.

In yet another embodiment the data set may contain multiple sub-data sets that may be conditioned in a plurality of the ways described above. In one example, the administration module 140 requires that all data sets be assigned a number corresponding to the desired conditions set by a data provider 120. In one embodiment the number may be from zero to 999, or a substantially equivalent logical set. In one example, the assignment of a zero to a data conditions the data that it cannot be received by a data receiver 130. In one embodiment, the assignment of 1 indicates that the data may be received by a data receiver 130 at random. In one embodiment, the assignment of the number 999 indicates that the next data received from that data provider 120 to any data receiver 130 will be that data; that is, a data set with the assigned number of 999 is the top condition. A condition may be set by a number from 2 to 998. In this embodiment, a data receiver 130 will receive the data in the order at which they are conditioned. For example, if three data sets are conditioned in numbers 3, 4, and 5, a data receiver 130 may receive the data conditioned as 5 first, that conditioned as 4 second, and that conditioned as 3 last.

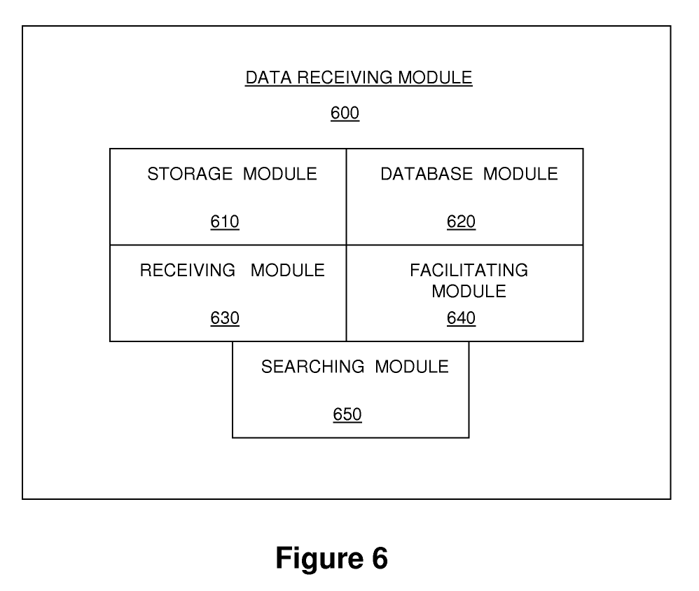

FIG. 6 is a block diagram showing a data receiving module 600 according to one embodiment of the invention. A data receiving module 600 includes a plurality of modules for carrying out one or more functions associated with the data receiving module 600. There is shown a data receiving module 600 including: a storage module 610; a database module 620; a receiving module 630; a facilitating module 640; and a searching module 650. The data receiving module 600 may be required to install and/or configure a plurality of modules to receive messages.

The storage module 610 stores data, such as but not limited to message information (e-mails, advertisements, documents, etc.), audio information (music files such as mp3 or wav files, etc.), video or picture information, and so forth. The storage module may include one or more storage devices, such as but not limited to a hard drive, and may include an OS system such as a Windows or DOS OS by Microsoft Corporation of Redmond, Wash. In one embodiment the storage module 610 may allow a data receiver 130 to save received data.

In another embodiment a data provider 120 and/or data provider 120 and data receiver 130 may elect to allow a data receiver 130 to save the data. In this embodiment, if a data receiver 130 is allowed to save the data, the data may be saved at either the data receiver module 130 or the administration module 140, or some other location know in the art. Some non-limiting examples of locations may include, a computer hard drive, a network, a server, memory, a floppy disk, a CD, a DVD, a memory card, a portable drive such as a USB drive, a cell phone, a personal data assistant, a global positioning system, a digital camera, computer tape, and so forth. A data receiver 130 may read the saved data. A data receiver 130 may modify the order in which the saved data is displayed. A data receiver 130 may delete the saved data.

In yet another embodiment, a data receiver 130 may not save the data to a location not embodied in the administration module. In one aspect of this embodiment, a data receiver 130 may re-read, re-receive, review, or navigate available data. In another aspect of this embodiment, a data receiver 130 may save a portion of the data, such as a title or subject line, but must re-read, re-receive, review, or navigate the available using the administration module 140.

The database module 620 stores, organizes, and/or includes meta-data relating to data sets. In one embodiment, MySQL by MySQL AB of Uppsala Sweden is included in the database module 620. The database 620 may allow a data receiver 130 to monitor statistical information regarding the data. For example, a data receiver 130 may configure either the receiving module 630 and/or the facilitating module 640 to monitor the statistical information. Some non-limiting examples of statistics may include: which data has been received; which data providers 120 send which data; from which data provider 120 is the most data received; from which data provider 120 is the least data received; from which data provider 120 does the data receiver 130 immediately elect to receive the data when the data receiver 130 is notified of the data; from which data provider 120 does the data receiver 130 elect to wait or not receive the data when the data receiver 130 is notified of the data; which data is received more than one time; how many times each data is received; from which data provider 120 is data repeatedly received; which data is saved; from which data provider 120 is data saved; from which data provider 120 is data not saved; and so forth.

The receiving module 630, in communication with the network module 110, enables a data receiver 130 to receive data. In one embodiment, the receiving module 630 enables a data receiver to satisfy a second condition. For example, a second condition being set by a data provider 120 requiring a data receiver 130 to receive a preliminary data set before receiving a subsequent data set. The receiving module 630 receiving the first data set enables a data receiver 130 to receive subsequent data sets.

In another embodiment the receiving module 630 may track the data providers 120 from which a data receiver 130 receives data. The receiving module 630 may suggest similar clients to those from which a data receiver 130 receives data. For example, if a data receiver 130 elects to receive data from several data providers 120 that publish data in the area of sports, the receiving module 630 may suggest other data providers 120 that publish data in the area of sports. A data receiver 130 may then elect to receive data from those other data providers 120.

In one example, data providers 120 are assigned call letters that may be similar to those used for radio stations. The receiving module 630 would allow a data receiver 130 to select the call letters of a data provider 120 from which a data receiver 130 will receive messages. In this example, interest in particular data providers 120 could easily be shared among users. This would facilitate data providers' desire to have more data receivers receiving its messages. In one example, the receiving module 630 may be opened in a window on the screen. The receiving module 630 window may be in the appearance of a radio tuner that lists the call letters of data providers 120 from which a data receiver 130 may receive messages.

The receiving module 630 may track data providers 120 from which a data receiver 130 receives messages. The receiving module 630 may suggest similar data providers 120 to those from which a data receiver 130 receives messages. For example, if a data receiver 130 elects to receive messages from several data providers 120 that publish messages in the area of sports, the receiving module 630 may suggest other data providers 120 that publish messages in the area of sports. A data receiver 130 may then elect to receive messages from those other data providers 120. A data receiver 130 may select from which data provider messages may be received. The administration module 140 may provide a data receiver 130 with a list of data providers 120.

The facilitating module 640 facilitates access to the administration module 140 for a data receiver 130. In one embodiment, the facilitating module 640 notifies a data receiver 130 of the first and second conditions for delivery of data from the data provider 120.

In another embodiment a data provider 120 may allow for any data receiver 130 to obtain the facilitating module 640. In another embodiment, a data provider 120 may allow only certain users to obtain the facilitating module 640. A data provider 120 could make the facilitating module 640 available to data receivers 130 through any means known in the art. Some non-limiting examples of making the facilitating module 640 available include: available for download from a web site; available through email at the user's request; available at a physical site of a data provider 120; available through mail-order or delivery from a data provider 120; available from the administration module l40; as pre-installed on devices acquired by a data receiver 130; and so forth.

In yet another embodiment, the facilitating module 640 and/or receiving module 630 will notify a data receiver 130 that a message is available using a window on a screen. The screen may be a physical component of any device capable of receiving a message. Some non-limiting examples of such devices include personal computers, laptop computers, personal data assistants, cellular telephones, automobile navigation systems, global positioning systems, and so forth. The window may be displayed on top of all other open windows on the screen. The window may be behind any open windows on the screen. The window may be temporary, that is, it fades away after a predetermined amount of time. The window may be permanent until the Data Receiver 130 acknowledges the window.

The acknowledgement may be by any method known, such as pointing and clicking, depressing an assigned key, depressing an assigned button, touching a defined area, and so forth. The acknowledgement may be by directing an indicator such as a pointer, cursor, and so forth, to a defined area on the window, and choosing that area. The choosing may be by any method of choosing known in the art such as, for example, clicking a mouse button, pressing a certain key on a keypad or keyboard, clicking a touchpad button, touching the screen in the area, and so forth. The choosing a defined area may allow for the message to be received by a data receiver 130. The choosing a defined area may allow for the notification to cease for a predetermined amount of time. In another embodiment, the notification continues until a data receiver 130 receives the message by choosing a defined area on the window. In another embodiment, a data receiver 130 may elect not to receive the message by choosing a defined area on the window, such as by clicking a “cancel” box.

The acknowledgement may be by pressing or clicking a predetermined key on a keyboard, keypad, or similar device. In one embodiment, the window directs a data receiver 130 as to which key must be pressed to acknowledge the window. The acknowledgement may be an election to receive the data, an acknowledgment to wait a predetermined amount of time before being notified again, an acknowledgement to not receive the data, and so forth.

It should be noted that this invention may be set up to avoid unwanted data being sent to a data receiver 130. A data receiver 130 may be required several times to indicate that he does want the data. A he data receiver 130 may indicate his or her desire for obtaining the specific data by obtaining the facilitating module 640 and/or receiving module 630. A data receiver 130 may further indicates his desire for receiving specific data upon installation and/or configuration of the facilitating module 640 and/or the receiving module 630. The facilitating module 640 and/or receiving module 630 may contain specific questions as to whether a data receiver 130 desires to obtain specific data. A data receiver 130 indicates his or her desire to obtain a specific data by receiving the data instead of choosing not to receive the data if the facilitating software indicates to a data receiver 130 that a data is available. Further, a data receiver 130 indicates his desire to continue receiving specific data by failing to re-configure, remove, uninstall, or otherwise disabling the receiving and/or facilitating software. Because a data receiver 130 may be required in so many ways to indicate his or her desire to receive the data, this invention may be considered to ameliorate the problem with spam. This is because it is a data receiver 130 that pulls the data instead of a data provider 130 pushing the data to a data receiver 130.

It should further be noted that in one embodiment the data delivery system the system may deliver the data directly to the desktop of a data receiver 130. The desktop may include any display known in the art, such as, personal computer screens, laptop computer screens, cell phone screens, personal data assistant screens, global positioning systems screens, automobile navigation system screens, and so forth. The receiving module 630 and/or the facilitating module 640 may run in the system tray, and as described above, notify a data receiver 130 on the desktop when a data is available. A data receiver 130 may not need to run a web browser, an email program or the like to receive the data. In one embodiment, the receiving module 630 and/or facilitating module 640 may use a web browser to display the data. However, the notification that a data is available and the election to receive the data may be delivered directly to the desktop of a data receiver 130 without the use of a web browser or email program. In another embodiment, the receiving module 630 and/or facilitating module 640 do not require the use of a web browser to receive the data, but the data may be displayed using a component of the receiving module 630 and/or facilitating module 640.

Additionally, although the description may give certain embodiments of how the data receiver may be notified that data is ready to be received, one skilled in the art would recognize that there may be numbers possible methods that the facilitating module and/or receiving module may employ to notify the data receiver. For example, the notification may be by a sound instead of visual. The notification may be tactile. A tactile or audible notification may be especially important for a blind or deaf data receiver. A tactile notification may be akin to the “vibrate” setting on cell phones, pagers, and personal data assistants.

The searching module 650 may search for and display available data providers 120 from which a data receiver 130 may receive data. The searching module 650 may search for data providers 120 by any field known in the art. Some non-limiting examples of the fields may include: data provider name; data provider services; data provider industry; data provider products; data provider website meta-tags; data provider website name; data provider website address; data provider email address; data provider call letters; and so forth.

In another embodiment of the invention, data providers 120 include digital entertainment sources. According to this embodiment, entertainment producers such as, but not limited to, bands, artists, musicians, producers, recording labels, and so forth; may control the delivery of digital entertainment data according to the manner described above. Data receivers 130 may also search for, select, and receive the digital entertainment data from the above mentioned digital entertainment sources.

In yet another embodiment, data providers 120 include educational sources; such as, but not limited to, universities, high schools, professors, teacher, teacher's assistants, and so forth. A non-limiting example may include a professor who wishes to control the delivery of assignments and other class related data via a network.

In another embodiment, data providers 120 include corporations, professionals, and other business entities, wherein controlled delivery of data over a network is desired. A non-limiting example may include a large multi-national corporation desires to control the delivery and/or receipt of important corporate documents and/or announcements (i.e., limiting certain subsidiaries access to certain documents, announcing upcoming events and/or meetings, etc.).

Finally, an embodiment of the invention wherein data providers 120 include business advertisers, wherein the business can control delivery of advertisements. Data receivers 130 can advantageously select which business advertisers from which to receive data. A non-limiting example may include a sports store desiring to advertise a specific holiday sale. The sports store may set conditions that the advertising data is be delivered between the time periods surrounding the holiday. On the other end, a plurality of data receivers wishing to receive advertisements regarding sport stores may select to receive that advertising data. Therefore, only those data receivers desiring to receive the advertising data receive the data.

It is also envisioned that the modules may be integrated. For example, the facilitating module and the receiving module may be at least partially integrated. The integration may be sharing of operations. For example, when used together, both the facilitating and the receiving modules may contact the administration module to receive the message. It is envisioned that, the receiving module and the facilitating module could be completely integrated. In one example, the receiving module and the facilitating module are a single piece of software that performs all of the functions of both modules.

It is also envisioned that the modules may be installed on or part of separate devices. The administration module may be installed on a device physically separate from the device on which the receiving module and/or the facilitating module are installed. It is envisioned that the receiving module and the facilitating module may be installed on physically separate devices. For example, the receiving module may be installed on a cellular telephone personal computer, or other device with access to an intranet or the Internet, and the facilitating module may be installed on a device that does not have a connection to an intranet or the Internet, such as a personal data assistant. In this example, the devices may communicate (such as by infrared or radio frequency such as Bluetooth®) such that the device with the receiving module may transmit the received data to the device with the facilitating module so that the data receiver may view the received message.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claim rather than by the foregoing description. All changes which come within the meaning and range of equivalency of the claims are to be embraced within their scope.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims.

What is claimed is:

1. A system for controlling delivery of data, comprising:
a network module, configured to access a network;
a storage module, configured to store data;
a data publishing module in communication with the network module and storage module, configured to enable a data provider to upload and select a first and second condition;
a permission module, configured to provide access to the system upon satisfaction of a first condition and delivery of a data set upon satisfaction of a second condition.

2. The system of claim 1, wherein the second condition includes a preliminary data set.

3. The system of claim 2, wherein the second condition includes a receipt of confirmation of use of a preliminary data set.

4. The system of claim 1, wherein the second condition is not satisfied by mere interaction with a GUI.

5. The system of claim 1, wherein access to metadata is provided upon occurrence of a first condition.

6. The system of claim 1, wherein the first condition is satisfied by presentation of a key.

7. The system of claim 6, wherein the key includes a data receiver class, configured to categorize.

8. The system of claim 7, wherein the second condition is a selected data receiver class.

9. The system of claim 1, wherein the second condition is selected from the group of conditions including:
a passage of a first time period;
a passage of time;
a deliver of a preliminary data set;
a passage of a date;
a date;
an indication of approval from a data provider;
an indication of approval from a third party; and
a credit expenditure.

10. The system of claim 1, comprising a data receiver access module, including a website.

11. The system of claim 1, further comprising a data receiving module in communication with the network module, configured to receive data.

12. The system of claim 11, wherein the receiving module includes a condition satisfaction module, configured to enable a data receiver to satisfy a second condition.

13. The system of claim 1 further comprising a facilitating module, configured to facilitate access to the system.

14. The system of claim 13, wherein the facilitating module notifies a data receiver of a first data set.

15. The system of claim 13, wherein the facilitating module notifies the data receiver of a second condition.

16. A method for controlling the delivery of data, comprising:
providing access to a network;
receiving data;
storing data;
receiving a selection of a first condition;
receiving a selection of a second condition;
providing access to data upon satisfaction of the first condition;
delivering the data set upon satisfaction of the second condition.

17. The method of claim 16, wherein the second condition includes a preliminary data set.

18. The method of claim 16, wherein the second condition is selected from the group of conditions including:
a passage of a first time period;
a passage of time;
a deliver of a preliminary data set;
a passage of a date;
a date;
an indication of approval from a data provider;
an indication of approval from a third party; and
a credit expenditure.

19. An article of manufacture comprising:
a computer usable medium having computer readable program code embodied therein, the computer readable program code providing instruction for carrying out the steps of:
providing access to a network;
receiving data;
storing data;
receiving a selection of a first condition;
receiving a selection of a second condition;
providing access to data upon satisfaction of the first condition;
delivering the data set upon satisfaction of the second condition.

20. The article of manufacture of claim 19, wherein the second condition wherein the second condition is select from the group including:
a passage of a first time period;
a passage of time;
a deliver of a preliminary data set;
a passage of a date;
a date;
an indication of approval from a data provider;
an indication of approval from a third party; and
a credit expenditure.
